(19) United States
(12) Patent Application Publication
(10) Pub. No.: US 2018/0365403 A1
(43) Pub. Date: Dec. 20, 2018

(54) DATA PROCESSOR, DATA PROCESSING PERFORMANCE CONTROL METHOD, AND PROGRAM

(71) Applicant: KONICA MINOLTA, INC., Tokyo (JP)

(72) Inventor: Akemi MORITA, Nara-shi (JP)

(73) Assignee: KONICA MINOLTA, INC., Tokyo (JP)

(21) Appl. No.: 15/996,577

(22) Filed: Jun. 4, 2018

(30) Foreign Application Priority Data
Jun. 16, 2017 (JP) 2017-118821

(51) Int. Cl. G06F 21/32; H04N 1/00; G06K 9/00

(52) U.S. Cl. CPC G06F 21/32; H04N 1/00437; H04N 1/00875; H04N 1/00854; G06K 9/00899

(57) ABSTRACT

A data processor includes: a storage that stores a plurality of items of true/false determination information; a hardware processor that: receives an instruction of a data processing by a user; performs a data processing an instruction of which is received; selects a plurality of items of different true/false determination information from among the true/false determination information stored in the storage and sequentially presents the selected items of true/false determination information to a user; determines whether a user is authorized based on biological information of the user detected while the user is operating each item of true/false determination information sequentially presented; and performs a data processing when the hardware processor determines that the user is authorized, and stops performing a data processing when the hardware processor determines that the user is not authorized; and a biological information detector that detects biological information of a user who instructs a data processing.

The entire disclosure of Japanese patent Application No. 2017-118821, filed on Jun. 16, 2017, is incorporated herein by reference in its entirety.

### BACKGROUND

### Technological Field

The present invention relates to a data processor such as image forming apparatus, a data processing performance control method in the data processor, and a program.

### Description of the Related art

There has been conventionally well known a technique in which when a processing of transmitting an e-mail to an external transmission destination is performed as a data processing, for example, a confirmation screen of “Did you encrypted the attached document?” is presented before the data processing is performed in terms of security, and the data processing is performed only when the user presses the button “YES”.

However, there is a problem that it is not clear whether the user is authorized to perform the data processing even by presenting the confirmation screen on performing the data processing and by determining whether the button “YES” is pressed, and even if a user who is not authorized to perform the data processing falsely presses the button “YES”, the processing is performed and a malicious data processing cannot be prevented from being performed.

On the other hand, not only original receipts but also the scanned data of the originals is officially available for the expense processing in offices and the like. However, there is accordingly a problem that use of other person's receipt, repeated use of receipt, falsification of date and payment amount, and the like are easily done.

JP 2005-95615 A proposes, as a technique for detecting changes in emotion caused when a person tells a lie, and the like at high sensitivity, and confirming changes in emotion of a subject, a method for measuring the pulse waves at a plurality of sites of the body of a subject, detecting the temporal differences in the pulse waves at the respective sites, and confirming changes in emotion of the subject on the basis of the changes in the temporal differences of the pulse waves.

It is thus assumed that such a technique is applied to confirm whether a user is authorized to perform a data processing, and biological information of the user such as pulse waves is detected when the user presses the button “YES” on the confirmation screen presented before the user performs the data processing, thereby detecting a change in emotion caused when a person tells a lie, and the like on the basis of the biological information, and determining whether the user is authorized to perform the data processing on the basis of the detection result.

However, there is a problem that even if biological information of a user is detected, the user becomes accustomed to the question if the definite confirmation screen is only presented once before the data processing is performed, a change in biological information (change in emotion) is difficult to detect even if the user intentionally makes a wrong answer to a question, and whether the user is authorized cannot be accurately determined on the basis of the biological information.

### SUMMARY

The present invention has been made in terms of such a technical background, and an object thereof is to provide a data processor capable of accurately determining whether a user is authorized to perform his/her instructed data processing on the basis of biological information, a data processing performance control method, and a program.

To achieve the abovementioned object, according to an aspect of the present invention, a data processor reflecting one aspect of the present invention comprises: a storage that stores a plurality of items of true/false determination information; and a hardware processor that: receives an instruction of a data processing by a user; performs a data processing an instruction of which is received; selects a plurality of items of different true/false determination information from among the true/false determination information stored in the storage and sequentially presents the selected items of true/false determination information to a user after an instruction of a data processing is received before the data processing is performed; determines whether a user is authorized on the basis of biological information of the user detected by a biological information detector while the user is operating each item of true/false determination information sequentially presented; and performs a data processing when the hardware processor determines that the user is authorized, and stops performing a data processing when the hardware processor determines that the user is not authorized, wherein the biological information detector is provided separately from or integrally with the data processor and can detect biological information of a user who instructs a data processing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a configuration of a data processor according to an embodiment of the present invention;

FIG. 2 is a diagram for explaining the operations of the data processor when a user instructs a data processing on the data processor illustrated in FIG. 1;

FIG. 3 is a diagram illustrating how true/false determination information is classified and stored per type of a data processing;

FIG. 4 is a flowchart illustrating the operations of the data processor when a user instructs a data processing;

FIG. 5A is an explanatory diagram when a user instructs a data processing;

FIG. 5B is an explanatory diagram when a proxy user instructs a data processing;

FIG. 6 is a diagram illustrating history information of the past data processings; and

FIG. 7 is a block diagram illustrating a configuration of the data processor according to another embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

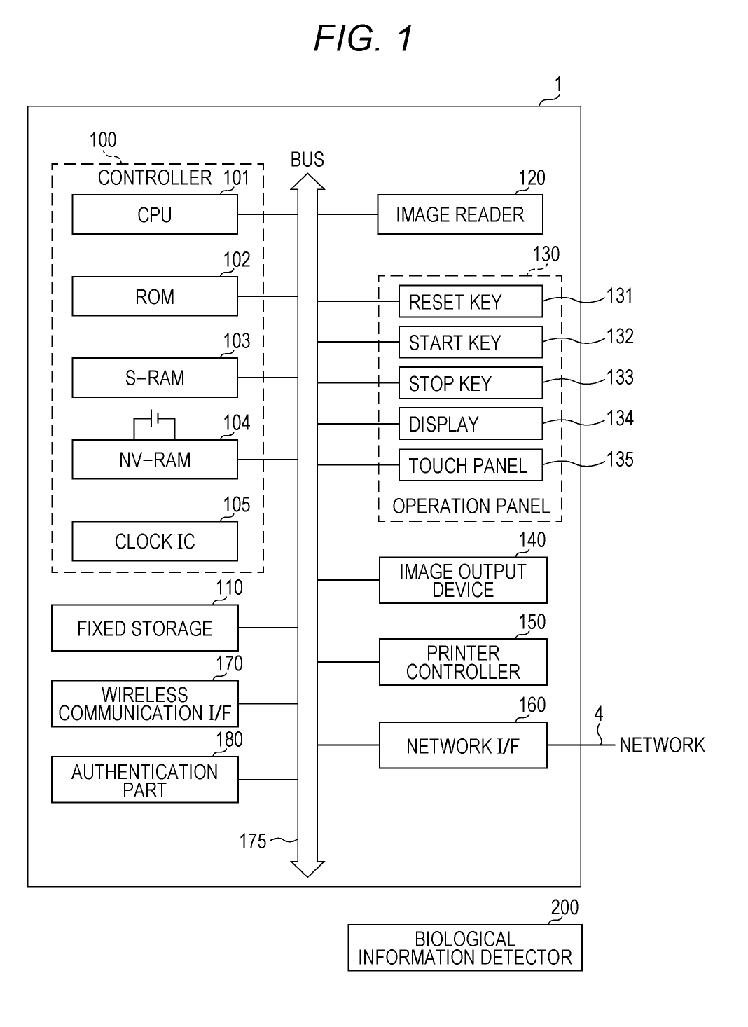

FIG. 1 is a block diagram illustrating a configuration of a data processor 1 according to an embodiment of the present invention. The data processor 1 according to the present embodiment employs a multi function peripheral (MFP) as multi-function digital image forming apparatus having the functions such as copy function, printer function, scan function, and facsimile function. The data processor will be also denoted as MFP in the following description.

As illustrated in FIG. 1, the MFP 1 includes a controller 100, a fixed storage 110, an image reader 120, an operation panel 130, an image output device 140, a printer controller 150, a network interface (network I/F) 160, a wireless communication interface (wireless communication I/F) 170, and an authentication part 180, which are mutually connected via a system bus 175. The MFP 1 further includes a biological information detector 200 separately from the MFP 1.

The controller 100 includes a central processing unit (CPU) 101, a read only memory (ROM) 102, a static random access memory (S-RAM) 103, a non volatile RAM (NV-RAM) 104, and a clock IC 105.

The CPU 101 executes the operation programs stored in the ROM 102 or the like thereby to collectively control the entire MFP 1. For example, the CPU 101 feasibly controls the copy function, the printer function, the scan function, the facsimile function, and the like. Further, according to the present embodiment, the CPU 101 receives a user-instructed data processing using at least any function of the above functions, receives user's biological information detected by the biological information detector 200, determines whether the user is authorized to perform the data processing or is true or whether the user is not authorized or is false, and controls performing the instructed data processing depending on a determination result, which will be described below in detail.

The ROM 102 stores programs executed by the CPU 101, and other data.

The S-RAM 103 is a work area when the CPU 101 executes the programs, and temporarily stores the programs or the data when the programs are executed.

The NV-RAM 104 is a nonvolatile memory backed up by a battery, and stores various settings and the like for image forming.

The clock IC 105 counts time, and functions as an internal timer to measure a processing time.

The fixed storage 110 is configured of a hard disc or the like, and stores programs or various items of data. Particularly according to the present embodiment, many questions are stored as true/false determination information presented to a user who instructs a data processing. The questions are classified per type of a data processing. The types of data processings are a print job of printing image data read by the image reader 120, a scan/transmission job of transmitting image data read by the image reader 120 to a predetermined destination, a job of reading and printing or transmitting document data stored in a box as a storage area in the fixed storage 110, and the like.

The image reader 120 includes a scanner or the like, scans and reads a document set on a platen glass, and converts the read document into image data.

The operation panel 130 is used by a user for instructing jobs or performing various settings on the MFP 1, and includes a reset key 131, a start key 132, a stop key 133, a display 134, and a touch panel 135.

The reset key 131 is used for resetting the settings, the start key 132 is used for starting scanning and the like, and the stop key 133 is pressed for interrupting an operation.

The display 134 is configured of a liquid crystal display, for example, and directed for displaying messages or various operation screens, and the touch panel 135 is formed on a screen of the display 134 and is directed for detecting user's touch operations.

The image output device 140 is directed for printing image data of a document read by the image reader 120 or a copied image generated from print data transmitted from a terminal 3 on a sheet, and outputting the sheet as a printed material.

The printer controller 150 is directed for generating a copied image from print data received by the network interface 160.

The network I/F 160 functions as a communication part for exchanging data with an external apparatus, and the wireless communication I/F 170 is an interface for making wireless communication with the biological information detector 200 and the like via near field wireless communication.

The authentication part 180 is directed for acquiring authentication information of a user who logs in, and comparing and collating the authentication information with the information for collation previously stored in the fixed storage 110 or the like, thereby making authentication. It may be configured such that user's authentication information is compared and collated with the information for collation by an eternal authentication server and authentication is made when the authentication part 180 receives an authentication result from the authentication server.

The biological information detector 200 is directed for detecting biological information of a user who instructs a data processing, and transmitting the detected biological information to the MFP 1. The biological information changes depending on user's emotion, and user's pulse waves are detected according to the present embodiment. Further, the biological information detector 200 can continuously detect user's biological information (pulse waves) substantially while the user is answering a plurality of different questions displayed on the display 134 as described below, and thus, though not limited, employs a watch-type or band-type device mounted and used by the user on the arm. The watch-type or band-type biological information detector may store the authentication information of the user when he/she logs in, and in this case, the biological information detector 200 is made close to the authentication information reader in the MFP 1 when the user logs in the MFP 1 so that the MFP 1 automatically reads the authentication information stored in the biological information detector 200 and makes authentication.

Further, the biological information detector 200 may employ an apparatus for continuously shooting the face of a user, detecting a change in heartbeat of the user on the basis of the shot images, and transmitting the detected change in heartbeat to the MFP 1.

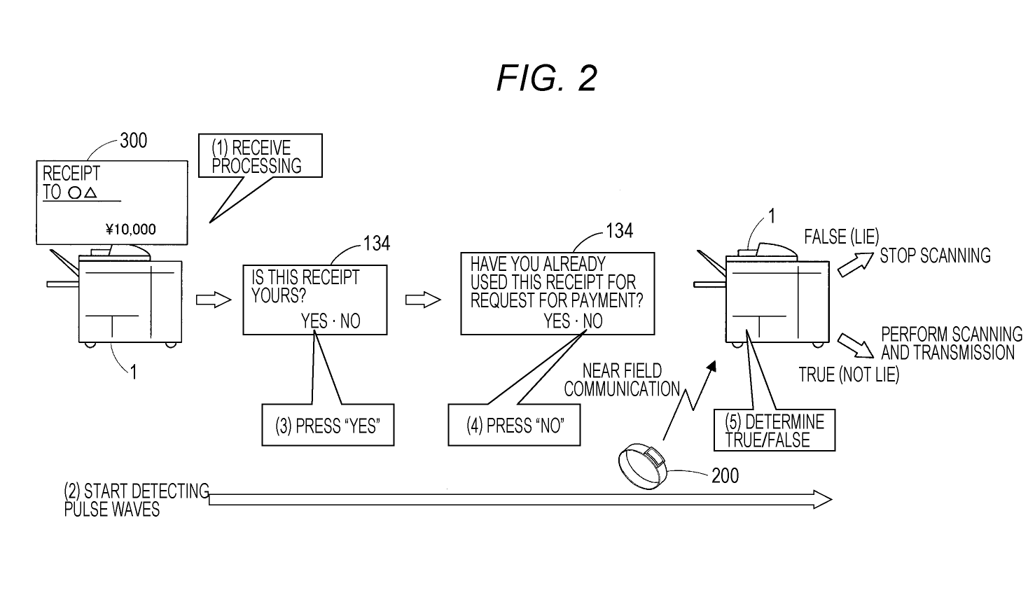

The operations of the MFP 1 when a user instructs a data processing on the MFP 1 illustrated in FIG. 1 will be described below with reference to FIG. 2. In this example, the description will be made assuming that a user-instructed data processing is that the image reader 120 reads and transmits a receipt 300 to a predetermined transmission destination. The MFP 1 is installed with an application dedicated for receipt processing, and is associated with an expense system (not illustrated), and the receipt 300 read by the image reader 120 is processed in the dedicated application and transmitted to the expense system.

As illustrated in FIG. 2, the user logs in the MFP 1 while he/she mounts the watch-type or band-type biological information detector 200 on the arm. When the user presses the activation button of the receipt processing application thereby to activate the application, and sets the receipt 300 on the image reader 120 and presses the start key 132 after logging in, the MFP 1 receives the processing of reading (scanning) the receipt and transmitting the scanned receipt to the expense system as a data processing ((1) in FIG. 2).

On the other hand, the biological information detector 200 mounted on user's arm continuously detects the pulse waves as user's biological information, and transmits the detected pulse waves to the MFP 1 ((2) in FIG. 2). The MFP 1 receives the pulse waves via the wireless communication I/F 170 immediately after the logging-in, analyzes the received pulse waves, and detects a change in emotion on the basis of the change in pulse waves.

The MFP 1 displays a question and the answer buttons for the user on the display 134 of the operation panel 130 while receiving the pulse waves after receiving the data processing and before performing the data processing. For example, a question of “Is the receipt is yours?” and the answer buttons “YES” and “NO” are displayed. When the user presses the button “YES” or “NO”, a next question of “Have you already used the receipt for a request for payment?” and the answer buttons “YES” and “NO” are displayed, for example. In this way, the MFP 1 sequentially presents a plurality of questions, and presents different questions and does not repeat the same questions such that the user unconsciously presses the button “YES” without reading the questions.

Further, it is desirable that a plurality of questions include questions with correct answers reversed in order to prevent the user from unconsciously answering. For example, an authorized user or a “true” user answers “YES” to the question of “Is the receipt yours?” ((3) in FIG. 2), and a “true” user answers “NO” to the question of “Have you already used the receipt for a request for payment?” ((4) in FIG. 2).

Other question of “Didn't′ you rewrite data or payment amount?” may be displayed together with the answer buttons “YES” and “NO”. Further, the selection buttons for selecting one of “A's?”, “B's?”, and “C's” may be displayed for a question of “whose is the receipt?” instead of the answer buttons “YES” and “NO”.

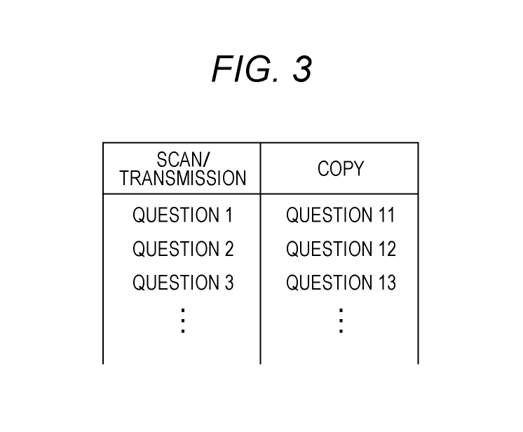

Further, according to the present embodiment, as illustrated in FIG. 3, the questions are classified per type of a data processing such as scan/transmission processing and copy processing, and are stored in the fixed storage 110 or the like, and a plurality of questions are selected and displayed from among a group of questions corresponding to the type of a data processing when the data processing is received, thereby presenting the accurate questions depending on a data processing.

While a plurality of questions are repeatedly displayed and answered, the biological information detector 200 transmits the detected user's biological information (pulse waves) to the MFP 1, and the MFP 1 analyzes the received biological information and determines whether a change in pulse waves exceeding a threshold is present, or whether the user is true or false ((5) in FIG. 2). When the user makes a false answer to a question, it is predicted that a change in pulse waves exceeds the threshold, and thus when a change in pulse waves exceeds the threshold, it is determined that the user makes a false answer and is false, or the user is not authorized to perform the data processing. When determining that the user is false, the MFP 1 stops scanning and does not perform the user-instructed data processing.

On the other hand, when a change in pulse waves does not exceed the threshold between the start and the end of the questions, it is determined that the user does not make the false answers and the user is true or authorized to perform the data processing. The MFP 1 performs the processing of scanning the receipt 300 and transmitting the scanned receipt 300 to the expense system as a user-instructed data processing when determining that the user is true.

Whether a change in pulse waves exceeds the threshold may be determined before or after the user presses an answer button, or whether a change in pulse waves exceeding the threshold is present may be determined from among the total pulse waves. Further, whether the user is true or false may be determined depending on whether an average value of the pulse waves in a certain period of time exceeds the threshold.

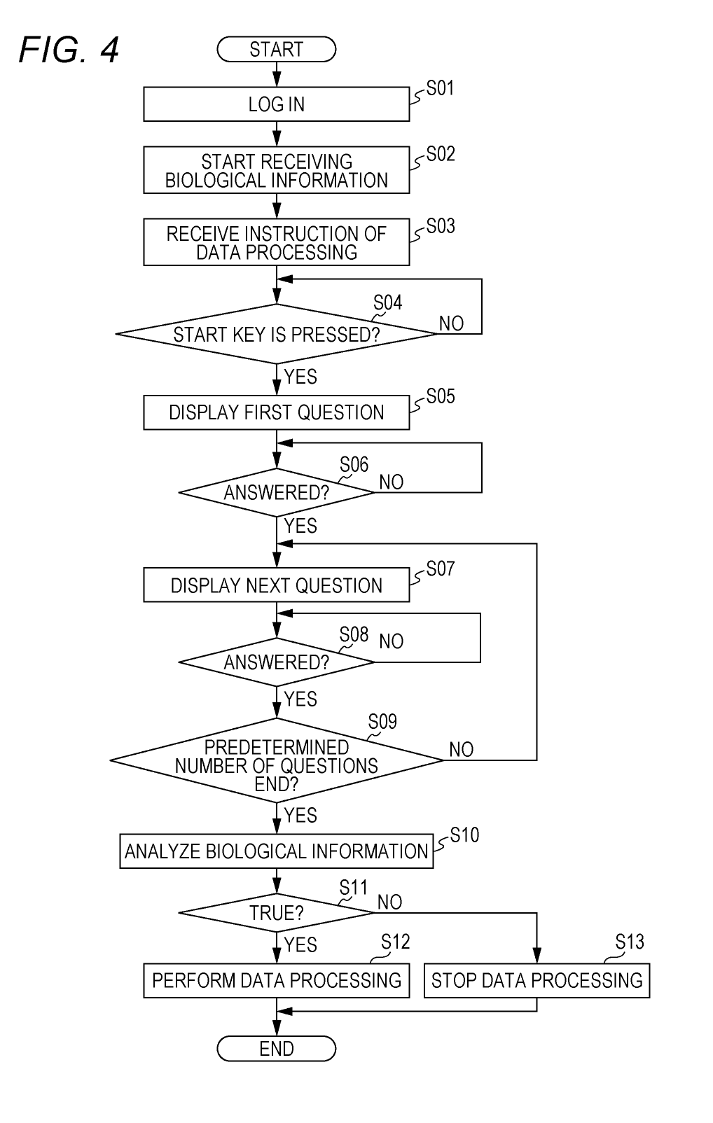

FIG. 4 is a flowchart illustrating the operations of the MFP 1 when a user instructs a data processing. The CPU 101 in the MFP 1 operates according to the operation programs stored in the ROM 102 or the like so that the operations illustrated in the flowchart are performed.

In step S01, when the CPU 101 permits user's login, in step S02, the CPU 101 starts receiving biological information transmitted from the biological information detector 200 mounted on user's arm or the like in near field wireless communication, and then in step S03, the CPU 101 receives a user-instructed data processing.

Then in step S04, the CPU 101 determines whether the start key 132 is pressed, and if not pressed (NO in step S04), waits for the start key 132 to be pressed. When the start key 132 is pressed (YES in step S04), in step S05, the CPU 101 displays the first question and the answer buttons on the display 134, and then determines in step S06 whether the answer is made or whether an answer button is pressed. If not answered (NO in step S06), the CPU 101 waits for the answer to be made, and when answered (YES in step S06), the CPU 101 displays a next question and the answer buttons on the display 134 in step 507.

In step S08, the CPU 101 determines whether the answer is made, and if not answered (NO in step S08), the CPU 101 waits for the answer to be made, and if answered (YES in step S08), the CPU 101 determines in step S09 whether a predetermined number of questions are terminated. The number of questions may be uniformly and previously set depending on the conditions such as type of a data processing or user, or irrespective of conditions. When not terminating a predetermined number of questions (NO in step S09), the CPU 101 returns to step S07 to display a next question and the answer buttons. When terminating a predetermined number of questions (YES in step S09), the CPU 101 analyzes the biological information in step S10, and determines in step S11 whether the user is true or false. When determining that the user is true (YES in step S11), the CPU 101 performs the received data processing in step S12. When determining that the user is false (NO in step S11), the CPU 101 stops the received data processing in step S13.

As described above, according to the present embodiment, a plurality of different questions are selected and sequentially displayed on the display 134 from among the questions stored in the fixed storage 110 or the like after an instruction of a data processing is received and before the data processing is performed. On the other hand, whether the user is authorized to perform the data processing, or true or whether the user is not authorized, or false is determined on the basis of the user's biological information (pulse waves) detected by the biological information detector 200 while the user is answering the respective questions sequentially displayed on the display 134, and the data processing is performed when the user is determined as true, and the data processing is stopped and is not performed when the user is determined as false.

That is, a plurality of different questions are sequentially presented to a user instructing to perform a processing, and the user's biological information is detected while the user is answering the respective questions, and thus the user's biological information more easily changes when the user intentionally makes a wrong answer than when a definite confirmation screen is presented once, thereby easily detecting a change in biological information (change in emotion). Thus, whether the user is authorized to perform the data processing can be accurately determined on the basis of the biological information, thereby preventing a malicious data processing from being performed. Further, the illegally-processed receipt 300 can be prevented from being used in the data processing, and thus it is possible to avoid determining whether the use is illegal after the receipt 300 is illegally used.

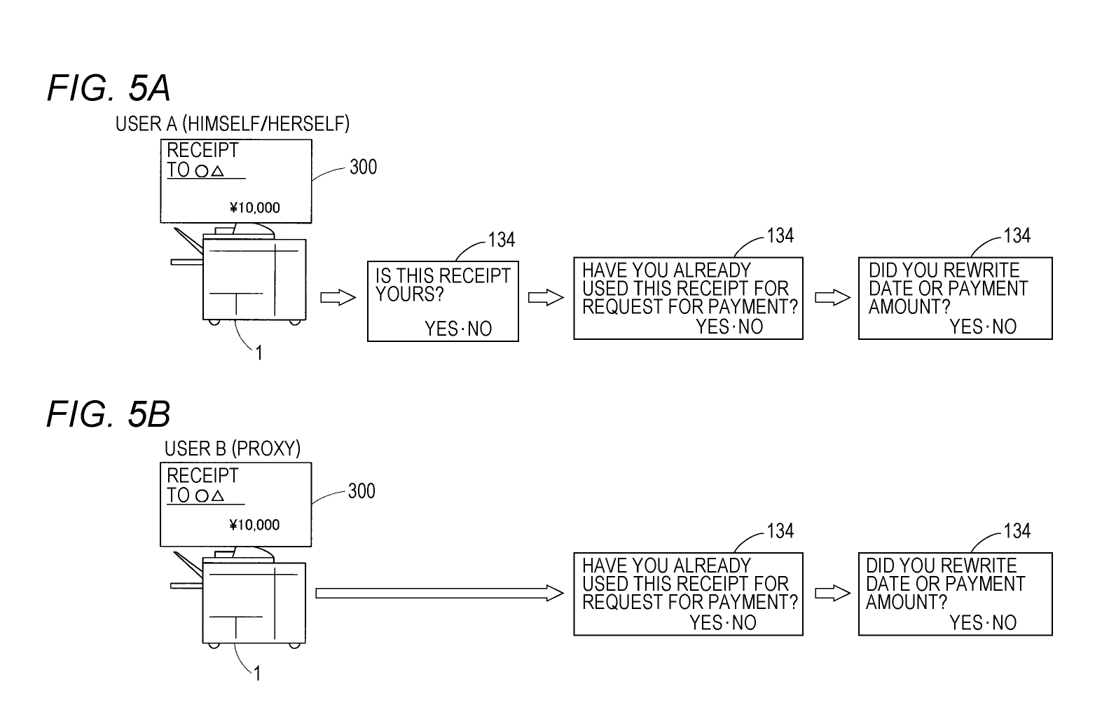

Other embodiment of the present invention will be described below with reference to FIG. 5A and FIG. 5B. The present embodiment indicates that the questions are changed between a user and his/her proxy person.

As illustrated in FIG. 5A, when a user A instructs a data processing of scanning and transmitting the receipt 300, the first question of “Is the receipt your?” and the answer buttons “YES” and “NO” are displayed. After the use A answers the first question, the second question of “Have you already used the receipt for a request for payment?” and the answer buttons “YES” and “NO” are displayed, and after the user answers the second question, the third question of “Did you rewrite date or payment amount?” and the answer buttons “YES” and “NO” are displayed.

To the contrary, as illustrating in FIG. 5B, when a proxy user B instructs the processing of scanning and transmitting the receipt 300, the first question of “Have you already used the receipt for a request for payment?” and the answer buttons “YES” and “NO” are displayed without presenting the question of “Is the receipt yours?” for ID confirmation, and after the first question is answered, the second question of “Did you rewrite date or payment amount?” and the answer buttons “YES” and “NO” are displayed. In this way, the questions are changed depending on the authority of a user, thereby avoiding the questions not effective for the user, and presenting the appropriate questions.

The presence of the authority of a data processing is previously registered in the MFP 1, and the MFP 1 may confirm it when a user logs in.

An embodiment of the present invention has been described above, but the present invention is not limited to the above embodiment. For example, the true/false determination information presented to a user may be different per user, or depending on the past history even for the same user.

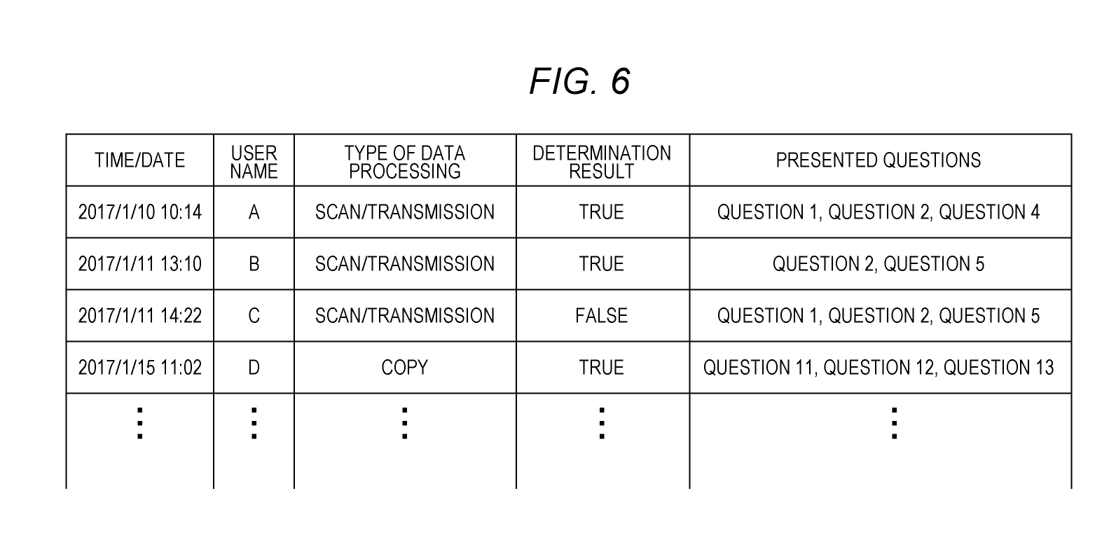

That is, as illustrated in FIG. 6, the MFP 1 stores time/date, user name, type of data processing, determination result, presented questions, and the like for the past data processings, as history information, in the fixed storage 110 or the like. The different questions are presented to the user A and the user B in the history. Further, it is desirable that not the questions presented in the past but new questions are presented to the user who has been asked the questions in order to prevent unconscious answer.

Further, it is desirable that the same questions as the past ones are made again to a user, such as a user C, who has been determined as “false”.

The scan/transmission processing is stopped when a user is determined as false according to the above embodiment, but the control method when a user is determined as “false” is not limited thereto. For example, the scan/transmission processing is performed but notification of the determination as “false” may be provided to an administrator via an e-mail or the like. Alternatively, scanned data may be added with attribute information such as caution mark. Alternatively, the log information of a destination apparatus may be additionally written, an alarm sound may be issued, or a determination result or a message “The transmission is determined as illegal. Do you transmit it?” may be displayed on the display 134. Alternatively, presenting the questions and detecting biological information may be performed again.

The description has been made assuming that a data processing is the scan/transmission processing, but when a data processing is to copy a document or the like, a plurality of questions including a question of “Copying for use?” are made, and copying is performed when the user is determined as “true”, and copying may be stopped when the user is determined as “false”. Further, when color copying is to be done, a plurality of questions including a question of “color copying is for external use. Are you copying the document for external use?” are made, color copying is performed when the user is determined as “true”, and aggregated copying that a plurality of sheets of a document are copied into one sheet for saving print sheets, or copying in double-faced mode may be performed while performing monochrome copying when the user is determined as “false”.

Further, when an important document for internal use only is to be printed, a plurality of questions including a question of “It is for internal use only. Do you use it outside?” are made, the document is printed when the user is determined as “true” and the print job may be discarded when the user is determined as “false”.

Further, when the data stored in the box in the fixed storage 110 configured of a hard disc in the MFP 1 is read, a plurality of questions including a question of “It is for internal use only. Do you use it outside?” are made, the data is read when the user is determined as “true”, and reading the data may be stopped when the user is determined as “false”.

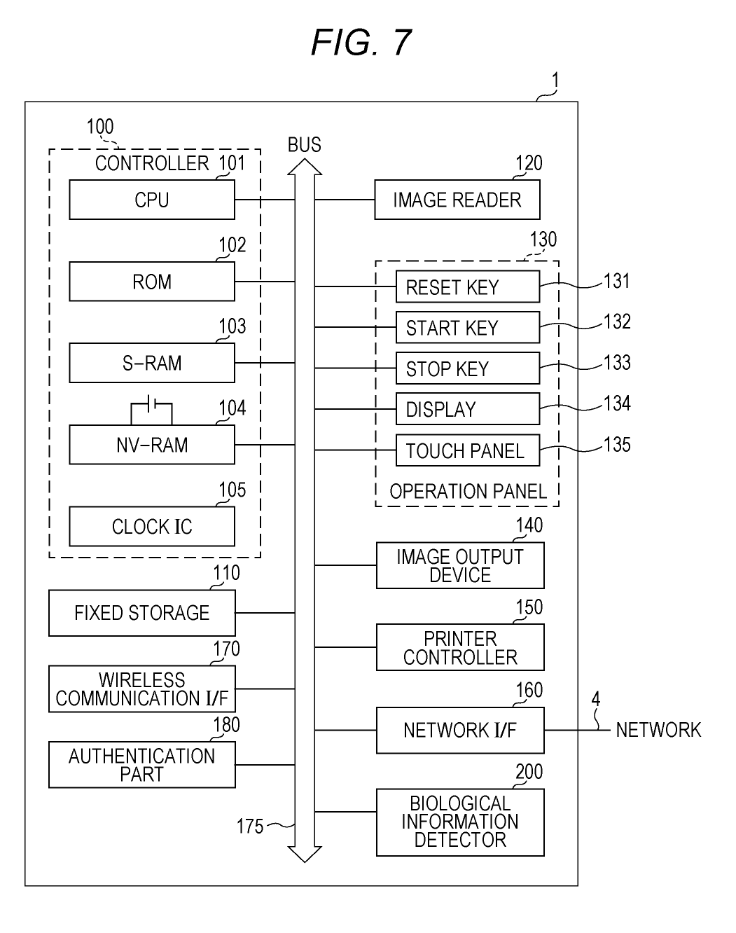

The above embodiment has been described assuming that the biological information detector 200 is provided separately from the MFP 1, but the biological information detector 200 may be integrally provided with the MFP 1 as illustrated in FIG. 7, and it may be configured such that a user touches or places his/her finger or hand on the biological information detector 200 on the MFP 1 thereby to continuously detect his/her biological information. The components in FIG. 7 are the same as in the MFP 1 in FIG. 1 except the biological information detector 200 provided in the MFP 1.

Further, the MFP 1 receives and analyzes biological information detected by the biological information detector 200 and determines whether a user is true or false according to the above embodiment, but the biological information detector 200 may analyze biological information and the MFP 1 may acquire the analysis result.

According to a first aspect of the present invention, a plurality of items of different true/false determination information are selected from among true/false determination information stored in a storage, and are sequentially displayed on a display after an instruction of a data processing is received and before the data processing is performed. On the other hand, a biological information detector capable of detecting biological information of a user who instructs a data processing is provided separately from or integrally with a data processor, whether a user is authorized or true or whether a user is not authorized or is false is determined on the basis of biological information of the user detected by the biological information detector while the user is operating the respective items of true/false determination information sequentially displayed on the display, the data processing is performed when the user is determined as true, and the data processing is not performed when the user is determined as false.

According to a second aspect of the present invention, a plurality of items of sequentially-displayed different true/false determination information are for a user, and whether the user is authorized can be accurately determined on the basis of biological information of the user when the user answers each question.

According to a third aspect of the present invention, a plurality of sequentially-displayed different questions include questions with correct answers reversed, and thus the user can be prevented from unconsciously answering the questions, the biological information of the user more easily changes when the user intentionally makes a wrong answer, and whether the user is true or false can be more accurately determined.

According to a fourth aspect of the present invention, a plurality of items of sequentially-displayed different true/false determination information are different per user, and thus the same true/false determination information is not necessarily presented even if a user knows the true/false determination information for other person, thereby accurately determining whether the user is true or false.

According to a fifth aspect of the present invention, a plurality of items of sequentially-displayed different true/false determination is different depending on the authority given to a user, thereby accurately determining whether the user is true or false depending on the authority given to the user.

According to a sixth aspect of the present invention, the true/false determination information is classified per type of a data processing, and a plurality of items of different true/false determination information are selected from the classification corresponding to a received data processing, and displayed on the display, thereby determining whether the user is true or false with higher accuracy by use of the appropriate true/false determination information depending on the type of the data processing.

According to a seventh aspect of the present invention, the biological information changes depending on a change in user's emotion, and thus the biological information of the user more easily changes when he/she intentionally makes a wrong answer, and a change in biological information (change in emotion) can be more easily detected.

According to an eighth aspect of the present invention, the biological information detector continuously detects biological information of a user while the user is operating each of a plurality of items of different true/false determination information displayed on the display.

According to a ninth aspect of the present invention, the biological information detector is provided separately from the data processor, biological information detected by the biological information detector is transmitted to the data processor, and whether the user is true or false is determined on the basis of the biological information transmitted from the biological information detector.

According to a tenth aspect of the present invention, when a true/false determination part determines that the user is false, the user-instructed data processing is stopped or the data processing is performed and notification of the true/false determination result is provided, thereby preventing the data processing from being performed by the unauthorized user.

According to an eleventh aspect of the present invention, when the true/false determination part determines that the user is false, notification of the true/false determination result is provided by at least any of e-mail transmission to the manager of the data processor, write into log information, or when a data processing is a document image reading processing, addition of attribute information to image data obtained by the reading, and display on the display, and thus the manager or the like can easily know that the data processing is performed by the unauthorized user.

According to a twelfth aspect of the present invention, when the true/false determination part determines that the user is true, a processing of printing data to be printed on a sheet is performed.

According to a thirteenth aspect of the present invention, when the true/false determination part determines that the user is true, a processing of transmitting data to be transmitted to a transmission destination is performed.

According to a fourteenth aspect of the present invention, when the true/false determination part determines that the user is true, a processing of outputting color data is performed.

According to a fifteenth aspect of the present invention, when the true/false determination part determines that the user is true, a processing of reading data from the storage is performed.

According to a sixteenth aspect of the present invention, when the true/false determination part determines that the user is true, a processing of printing data to be printed on a sheet in color is performed, and when the user is determined as false, a processing of printing data to be printed on a sheet in monochrome is performed.

According to a seventeenth aspect of the present invention, a plurality of items of different true/false determination information are sequentially presented to a user who instructs to perform a processing, and biological information of the user is detected while the user is operating each item of true/false determination information, and thus the biological information of the user easily changes when he/she intentionally makes a wrong answer than when a definite confirmation screen is presented once, thereby easily detecting a change in biological information (change in emotion). Thus, whether the user is authorized can be determined on the basis of the biological information, thereby preventing a malicious data processing from being performed.

According to an eighteenth aspect of the present invention, a computer in the data processor can be caused to perform selecting a plurality of items of different true/false determination information from among the true/false determination information stored in the storage and sequentially displaying the items of true/false determination information on the display after an instruction of a data processing is received and before the data processing is performed, determining whether a user is authorized or true or whether a user is not authorized or is false on the basis of biological information of the user detected by the biological information detector while the user is operating each item of displayed true/false determination information, causing the data processing to be performed when the user is determined as true, and causing the data processing not to be performed when the user is determined as false.

Although embodiments of the present invention have been described and illustrated in detail, the disclosed embodiments are made for purposes of illustration and example only and not limitation. The scope of the present invention should be interpreted by terms of the appended claims.

What is claimed is:

1. A data processor comprising:
a storage that stores a plurality of items of true/false determination information; and
a hardware processor that:
receives an instruction of a data processing by a user;
performs a data processing an instruction of which is received;
selects a plurality of items of different true/false determination information from among the true/false determination information stored in the storage and sequentially presents the selected items of true/false determination information to a user after an instruction of a data processing is received before the data processing is performed;
determines whether a user is authorized on the basis of biological information of the user detected by a biological information detector while the user is operating each item of true/false determination information sequentially presented; and
performs a data processing when the hardware processor determines that the user is authorized, and stops performing a data processing when the hardware processor determines that the user is not authorized,
wherein the biological information detector is provided separately from or integrally with the data processor and can detect biological information of a user who instructs a data processing.

2. The data processor according to claim 1,
wherein the hardware processor selects different true/false determination information from the true/false determination information presented in the past before a data processing, and presents the selected true/false determination information to a user.

3. The data processor according to claim 2,
wherein a plurality of items of sequentially-presented different true/false determination information are questions for a user, and an operation of the user for each item of true/false determination information is an operation of answering each question.

4. The data processor according to claim 3,
wherein a plurality of sequentially-presented different questions include questions with correct answers reversed.

5. The data processor according to claim 1,
wherein a plurality of items of sequentially-presented different true/false determination information are different per user.

6. The data processor according to claim 1,
wherein a plurality of items of sequentially-presented different true/false determination information are different depending on the authority given to a user.

7. The data processor according to claim 1,
wherein the true/false determination information is classified per type of a data processing, and the hardware processor selects a plurality of items of different true/false determination information from the classification corresponding to a data processing received, and sequentially presents the selected items of true/false determination information.

8. The data processor according to claim 1,
wherein the biological information changes depending on user's emotion.

9. The data processor according to claim 1,
wherein the biological information detector can continuously detect biological information of a user while the user is operating each item of true/false determination information sequentially presented.

10. The data processor according to claim 1,
wherein the biological information detector is provided separately from the data processor and transmits biological information detected by the biological information detector to the data processor, and the hardware processor determines whether the user is true or false on the basis of the biological information transmitted from the biological information detector.

11. The data processor according to claim 1,
wherein when the hardware processor determines that the user is false, the hardware processor stops the user-instructed data processing, or causes the data processing to be performed but provides notification of the true/false determination result.

12. The data processor according to claim 11,
wherein notification of a true/false determination result is provided by at least any of e-mail transmission to the manager of the data processor, write into log information, or when a data processing performed by the hardware processor is a document image reading processing, addition of attribute information to the image data obtained by the reading, and presentation.

13. The data processor according to claim 1,
wherein when a data processing performed by the hardware processor is a processing of printing data to be printed on a sheet and the hardware processor determines that the user is true, the hardware processor performs the processing of printing data to be printed on a sheet.

14. The data processor according to claim 1,
wherein when a data processing performed by the hardware processor is a processing of transmitting data to be transmitted to an external transmission destination and the hardware processor determines that the user is true, the hardware processor performs the processing of transmitting data to be transmitted to an external transmission destination.

15. The data processor according to claim 1,
wherein when a data processing performed by the hardware processor is a processing of outputting color data and the hardware processor determines that the user is true, the hardware processor performs the processing of outputting color data.

16. The data processor according to claim 1,
wherein when a data processing performed by the hardware processor is a processing of reading data from the storage and the hardware processor determines that the user is true, the hardware processor performs the processing of reading data from the storage.

17. The data processor according to claim 1,
wherein when a data processing performed by the hardware processor is a processing of printing data to be printed on a sheet in color or monochrome and the hardware processor determines that the user is true, the hardware processor performs the processing of printing data to be printed on a sheet in color, and when the hardware processor determines that the user is false, the hardware processor performs the processing of printing data to be printed in monochrome.

18. A data processor comprising:
a storage that stores a plurality of items of true/false determination information; and
a hardware processor that:
receives an instruction of a data processing by a user;
performs a data processing an instruction of which is received;
selects any item of true/false determination information from among the true/false determination information stored in the storage and presents the selected item of true/false determination information to a user after an instruction of a data processing is received before the data processing is performed;
determines whether a user is authorized on the basis of biological information of the user detected by a biological information detector while the user is operating true/false determination information presented; and
performs a data processing when the hardware processor determines that the user is authorized, and stops performing a data processing when the hardware processor determines that the user is not authorized,
wherein the biological information detector is provided separately from or integrally with the data processor and can detect biological information of a user who instructs a data processing, and
wherein the hardware processor selects different true/false determination information from the true/false determination information presented in the past before a data processing, and presents the selected different true/false determination information to a user.

19. A data processing performance control method,
wherein a data processor includes a biological information detector that is provided separately from or integrally with the data processor and can detect biological information of a user who instructs a data processing, and a storage that stores a plurality of items of true/false determination information, and performs:
receiving an instruction of a data processing by a user;
performing a data processing an instruction of which is received in the receiving;
selecting a plurality of items of different true/false determination information from among the true/false determination information stored in the storage and sequentially presenting the selected item of true/false determination information to a user after an instruction of a data processing is received in the receiving before the data processing is performed in the performing;
determining whether a user is authorized on the basis of biological information of the user detected by the biological information detector while the user is operating each item of sequentially-presented true/false determination information; and
performing a data processing when the user is determined as authorized in the determining, and stopping performing a data processing when the user is determined as unauthorized in the determining

20. A data processing performance control method,
wherein a data processor includes a biological information detector that is provided separately from or integrally with the data processor and can detect biological information of a user who instructs a data processing, and a storage that stores a plurality of items of true/false determination information, and performs:
receiving an instruction of a data processing by a user;
performing a data processing an instruction of which is received in the receiving;
selecting any item of true/false determination information from among the true/false determination information stored in the storage and presenting the selected item of true/false determination information to a user after an instruction of a data processing is received in the receiving before the data processing is performed in the performing;
determining whether a user is authorized on the basis of biological information of the user detected by the biological information detector while the user is operating presented true/false determination information; and
performing a data processing when the user is determined as authorized in the determining, and stopping performing a data processing when the user is determined as unauthorized in the determining,
wherein different true/false determination information from the true/false determination information presented in the past before a data processing are selected and presented to a user in the presenting

21. A non-transitory recording medium storing a computer readable program causing a computer in a data processor including a biological information detector that is provided separately from or integrally with the data processor and can detect biological information of a user who instructs a data processing, and a storage that stores a plurality of items of true/false determination information, to perform:
receiving an instruction of a data processing by a user;
performing a data processing an instruction of which is received in the receiving;
selecting a plurality of items of different true/false determination information from among the true/false determination information stored in the storage and sequentially presenting the selected item of true/false determination information to a user after an instruction of a data processing is received in the receiving before the data processing is performed in the performing;
determining whether a user is authorized on the basis of biological information of the user detected by the biological information detector while the user is operating each item of sequentially-presented true/false determination information; and
performing a data processing when the user is determined as authorized in the determining, and stopping performing processing when the user is determined as unauthorized in the determining.

22. A non-transitory recording medium storing a computer readable program causing a computer in a data processor including a biological information detector that is provided separately from or integrally with the data processor and can detect biological information of a user who instructs a data processing, and a storage that stores a plurality of items of true/false determination information, to perform:
receiving an instruction of a data processing by a user;
performing a data processing an instruction of which is received in the receiving;
selecting any item of true/false determination information from among the true/false determination information stored in the storage and presenting the selected item of true/false determination information to a user after an instruction of a data processing is received in the receiving before the data processing is performed in the performing;
determining whether a user is authorized on the basis of biological information of the user detected by the biological information detector while the user is operating presented true/false determination information; and
performing a data processing when the user is determined as authorized in the determining, and stopping performing a data processing when the user is determined as unauthorized in the determining,
wherein different true/false determination information from the true/false determination information presented in the past before a data processing is selected and presented to a user in the presenting
